(19) United States
(12) Patent Application Publication
(10) Pub. No.: US 2025/0317770 A1
(43) Pub. Date: Oct. 9, 2025

(54) MODEL MONITORING METHOD AND APPARATUS FOR INTELLIGENT BEAM MANAGEMENT

(71) Applicant: Electronics and Telecommunications Research Institute, Daejeon (KR)

(72) Inventors: Yong Jin KWON, Daejeon (KR); Seungjae BAHNG, Daejeon (KR); Youngjoon YOON, Daejeon (KR); Anseok LEE, Daejeon (KR); Heesoo LEE, Daejeon (KR); Yunjoo KIM, Daejeon (KR); Hyun Seo PARK, Daejeon (KR); Jungsook BAE, Daejeon (KR); Jungbo SON, Daejeon (KR); Yu Ro LEE, Daejeon (KR)

(21) Appl. No.: 19/171,080

(22) Filed: Apr. 4, 2025

(30) Foreign Application Priority Data
Apr. 5, 2024 (KR) 10-2024-0046974
May 10, 2024 (KR) 10-2024-0061970
Aug. 9, 2024 (KR) 10-2024-0106707
Oct. 2, 2024 (KR) 10-2024-0134364
Jan. 24, 2025 (KR) 10-2025-0011455
Apr. 2, 2025 (KR) 10-2025-0042822

(51) Int. Cl. H04W 24/08; H04L 5/00; H04L 41/16

(52) U.S. Cl. CPC H04W 24/08; H04L 5/0048; H04L 41/16

(57) ABSTRACT

A method of a user equipment (UE) may comprising: receiving a reference signal for at least one beam from a base station; obtaining a performance measurement result by measuring a performance of each of the at least one beam based on the reference signal; obtaining a performance prediction result of each of the at least one beam from an AI/ML model based on the performance measurement result; determining a performance metric of the AI/ML model based on the performance prediction result; and determining an operation of the AI/ML model by monitoring the performance metric.

### CROSS-REFERENCE TO RELATED APPLICATIONS

This application claims priority to Korean Patent Applications No. 10-2024-0046974, filed on Apr. 5, 2024, No. 10-2024-0061970, filed on May 10, 2024, No. 10-2024-0106707, filed on Aug. 9, 2024, No. 10-2024-0134364, filed on Oct. 2, 2024, No. 10-2025-0011455, filed on Jan. 24, 2025, and No. 10-2025-0042822, filed on Apr. 2, 2025, with the Korean Intellectual Property Office (KIPO), the entire contents of which are hereby incorporated by reference.

### BACKGROUND

### 1. Technical Field

The present disclosure relates to an AI/ML (artificial intelligence/machine learning) technique for a communication network, and more particularly, to a method and an apparatus for monitoring performance of the AI/ML model performing intelligent beam management.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, discussions on utilizing AI/ML technologies based on artificial intelligence (AI) models or machine learning (ML) models (e.g. AI/ML models) in communication systems are being actively conducted. In the 3GPP, researches on AI/ML technologies for NR air interfaces is being carried out. The AI/ML technologies may be utilized in various fields, such as channel state information (CSI) feedback enhancement, beam management enhancement, or positioning accuracy enhancement in communication systems.

The AI/ML technologies may be implemented by performing a specific AI/ML functionality using AI/ML model(s) in a plurality of communication nodes, such as a base station and a terminal (e.g. user equipment (UE)). Since the AI/ML technologies are based on training data, lifecycle management (LCM) may be performed for creation or maintenance of the AI/ML models according to a change in training data. The LCM of the AI/ML models may include detailed steps such as data collection, model training, deployment, model activation, inference, model monitoring, model deactivation, model selection, model switching, or model fallback.

To improve the performance of AI/ML models that perform AI/ML functions, accurate decisions regarding LCM operations of the AI/ML models may be required. For this purpose, a monitoring method for the performance of the AI/ML models is required.

### SUMMARY

The present disclosure for resolving the above-described problems is directed to providing a model monitoring method and apparatus for determining life cycle management operations of an AI/ML model through monitoring on performance metric(s) of the AI/ML model.

A method of a user equipment (UE), according to an exemplary embodiment of the present disclosure, may comprise: receiving a reference signal (RS) for at least one beam from a base station; obtaining a performance measurement result by measuring a performance of each of the at least one beam based on the reference signal; obtaining a performance prediction result of each of the at least one beam from an artificial intelligence (AI)/machine learning (ML) model based on the performance measurement result; determining a performance metric of the AI/ML model based on the performance prediction result; and determining an operation of the AI/ML model by monitoring the performance metric.

The determining of the performance metric may comprise: transmitting, to the base station, beam information including the performance measurement result and the performance prediction result; and receiving, from the base station, the performance metric of the AI/ML model determined based on the beam information.

The determining of the performance metric may comprise: determining, as the performance metric, a probability that a beam having a maximum value in the performance measurement result among the at least one beam is included in the performance prediction result.

The determining of the performance metric may comprise: determining, as the performance metric, a difference between the performance measurement result and the performance prediction result.

The determining of the operation of the AI/ML model may comprise: monitoring whether the performance metric satisfies a preconfigured performance condition; and determining one operation among life cycle management (LCM) operations of the AI/ML model based on a result of the monitoring.

The determining of the operation of the AI/ML model may further comprise: determining whether an event occurs based on the result of the monitoring; in response to the event occurring, transmitting an event occurrence report to the base station; and receiving, from the base station, information on the operation of the AI/ML model determined based on the event occurrence report.

The determining of whether the event occurs may comprise: increasing a count value whenever the performance metric fails to satisfy the performance condition for a preset time; and in response to the increased count value being equal to or greater than a preset threshold, determining occurrence of the event.

The determining of the operation of the AI/ML model may comprise: transmitting the performance metric to the base station; and receiving, from the base station, information on the operation of the AI/ML model determined based on the performance metric.

The method may further comprise: assigning a monitoring identifier (ID) to at least one of the performance measurement result, the performance prediction result, or the performance metric; and transmitting the monitoring ID to the base station.

A method of a base station, according to an exemplary embodiment of the present disclosure, may comprise: transmitting a reference signal (RS) for at least one beam to a user equipment (UE); receiving, from the UE, a performance measurement result for each of the at least one beam; obtaining a performance prediction result for each of the at least one beam from an artificial intelligence (AI)/machine learning (ML) model based on the performance measurement result; determining a performance metric of the AI/ML model based on the performance prediction result; monitoring the performance metric to determine an operation of the AI/ML model; and transmitting information on the determined operation of the AI/ML model to the UE.

The determining of the performance metric may comprise: determining, as the performance metric, one of a probability that a beam having a maximum value in the performance measurement result among the at least one beam is included in the performance prediction result or a difference between the performance measurement result and the performance prediction result.

The determining of the operation of the AI/ML model may comprise: monitoring whether the performance metric satisfies a preconfigured performance condition; and determining one operation among life cycle management (LCM) operations of the AI/ML model based on a result of the monitoring.

A user equipment (UE), according to an exemplary embodiment of the present disclosure, may comprise: at least one processor, wherein the at least one processor may cause the UE to perform: receiving a reference signal (RS) for at least one beam from a base station; obtaining a performance measurement result by measuring a performance of each of the at least one beam based on the reference signal; obtaining a performance prediction result of each of the at least one beam from an artificial intelligence (AI)/machine learning (ML) model based on the performance measurement result; determining a performance metric of the AI/ML model based on the performance prediction result; and determining an operation of the AI/ML model by monitoring the performance metric.

The at least one processor may further cause the UE to perform: transmitting, to the base station, beam information including the performance measurement result and the performance prediction result; and receiving, from the base station, the performance metric of the AI/ML model determined based on the beam information.

The at least one processor may further cause the UE to perform: determining, as the performance metric, one of a probability that a beam having a maximum value in the performance measurement result among the at least one beam is included in the performance prediction result or a difference between the performance measurement result and the performance prediction result.

The at least one processor may further cause the UE to perform: monitoring whether the performance metric satisfies a preconfigured performance condition; and determining one operation among life cycle management (LCM) operations of the AI/ML model based on a result of the monitoring.

The at least one processor may further cause the UE to perform: determining whether an event occurs based on the result of the monitoring; in response to the event occurring, transmitting an event occurrence report to the base station; and receiving, from the base station, information on the operation of the AI/ML model determined based on the event occurrence report.

The at least one processor may further cause the UE to perform: increasing a count value whenever the performance metric fails to satisfy the performance condition for a preset time; and in response to the increased count value being equal to or greater than a preset threshold, determining occurrence of the event.

The at least one processor may further cause the UE to perform: transmitting the performance metric to the base station; and receiving, from the base station, information on the operation of the AI/ML model determined based on the performance metric.

The at least one processor may further cause the UE to perform: assigning a monitoring identifier (ID) to at least one of the performance measurement result, the performance prediction result, or the performance metric; and transmitting the monitoring ID to the base station.

According to the present disclosure, a UE or a base station in a communication network may determine a performance metric based on a beam performance prediction result output from an AI/ML model, and may determine one of a plurality of detailed operations for lifecycle management of the AI/ML model based on a monitoring result of a change in the performance metric. Accordingly, the UE or the base station can identify the accurate performance of the AI/ML model, thereby improving the operational performance of the AI/ML model, and the communication network can enhance the performance of AI/ML functionality utilizing the AI/ML model.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of a method for enhancing AI/ML CSI feedback in a communication network.

FIG. 4 is a conceptual diagram illustrating an exemplary embodiment of a method for enhancing AI/ML positioning in a communication network.

FIG. 5 is a conceptual diagram illustrating an exemplary embodiment of a method for AI/ML beam management in a communication network.

FIG. 6 is a conceptual diagram illustrating an exemplary embodiment of an AI/ML model for AI/ML beam management.

FIG. 7 is a conceptual diagram illustrating an exemplary embodiment of a method for AI/ML beam management using a UE-side AI/ML model.

FIG. 8 is a conceptual diagram illustrating an exemplary embodiment of a method for AI/ML beam management using a base station-side AI/ML model.

FIG. 9 is a sequence chart illustrating a first exemplary embodiment of a monitoring method for an AI/ML model for AI/ML beam management.

FIG. 10 is a sequence chart illustrating a second exemplary embodiment of a monitoring method for an AI/ML model for AI/ML beam management.

FIG. 11 is a sequence chart illustrating a third exemplary embodiment of a monitoring method for an AI/ML model for AI/ML beam management.

FIG. 12 is a sequence chart illustrating a fourth exemplary embodiment of a monitoring method for an AI/ML model for AI/ML beam management.

FIG. 13 is a sequence chart illustrating a fifth exemplary embodiment of a monitoring method for an AI/ML model for AI/ML beam management.

FIG. 14 is a sequence chart illustrating a sixth exemplary embodiment of a monitoring method for an AI/ML model for AI/ML beam management.

FIG. 15 is a sequence chart illustrating a seventh exemplary embodiment of a monitoring method for an AI/ML model for AI/ML beam management.

FIG. 16 is a sequence chart illustrating an eighth exemplary embodiment of a monitoring method for an AI/ML model for AI/ML beam management.

FIG. 17 is a conceptual diagram illustrating a first exemplary embodiment for ensuring consistency between training and inference of an AI/ML model for AI/ML beam management.

FIG. 18 is a conceptual diagram illustrating a second exemplary embodiment for ensuring consistency between training and inference of an AI/ML model for AI/ML beam management.

FIG. 19 is a conceptual diagram illustrating a first exemplary embodiment of a beam set configuration method for RS measurement of an AI/ML model for AI/ML beam management.

FIG. 20 is a conceptual diagram illustrating a second exemplary embodiment of a beam set configuration method for RS measurement of an AI/ML model for AI/ML beam management.

FIG. 21 is a conceptual diagram illustrating a third exemplary embodiment of a beam set configuration method for RS measurement of an AI/ML model for AI/ML beam management.

FIG. 22 is a conceptual diagram illustrating a first exemplary embodiment of an inference operation of an AI/ML model for spatial domain AI/ML beam management.

FIG. 23 is a conceptual diagram illustrating a second exemplary embodiment of an inference operation of an AI/ML model for spatial domain AI/ML beam management.

FIG. 24 is a conceptual diagram illustrating an exemplary embodiment of an inference operation of an AI/ML model for temporal domain AI/ML beam management.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

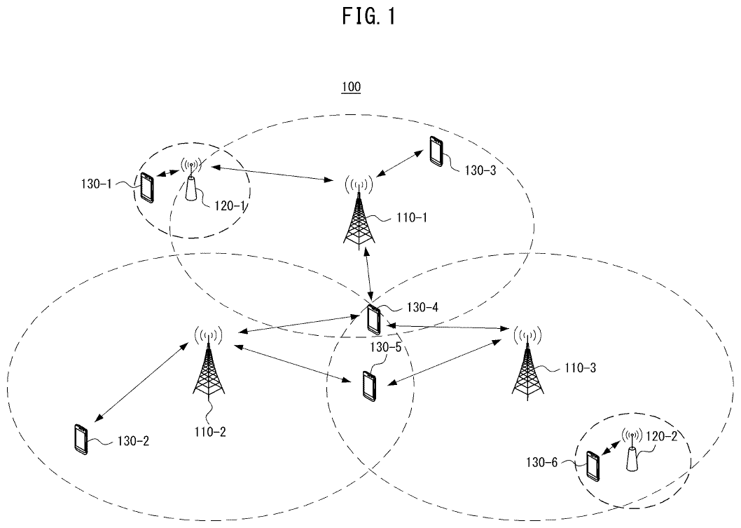

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user equipments (UEs) 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

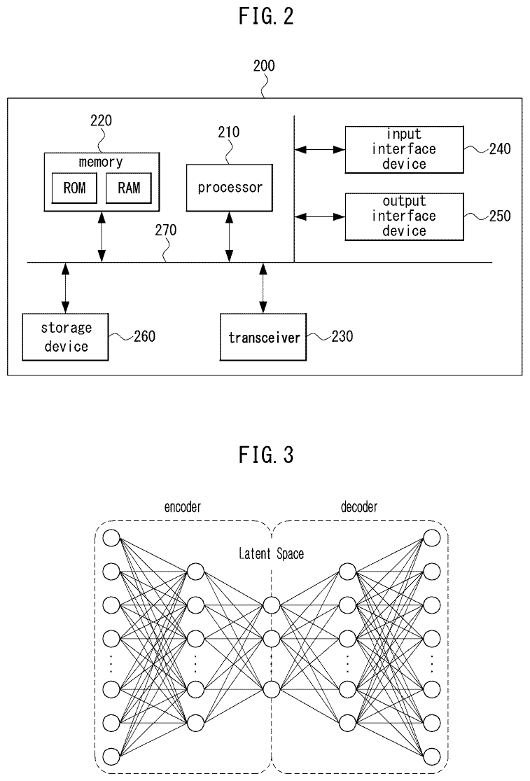

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The communication node 200 may include a model for performing an AI/ML (artificial intelligence/machine learning) functionality based on AI/ML technology, for example, an AI/ML model. The AI/ML model may be classified into a one-sided type model and a two-sided type model. The one-sided type model may refer to a type in which an AI/ML model is included in either a base station or a terminal (e.g. user equipment (UE)) among a plurality of communication nodes. The two-sided type model may refer to a type in which an AI/ML model is included in both a base station and a terminal among a plurality of communication nodes.

The communication node 200 may perform life cycle management (LCM) for the AI/ML functionality of the AI/ML model, model generation or maintenance, and the like. The LCM may include detailed steps such as data collection, model training, model inference, model deployment, model activation, model deactivation, model selection, model switching, model fallback, and model monitoring.

The communication node 200 may identify AI/ML functionalities supported by the communication network 100 or identify AI/ML models performing the AI/ML functionalities. For example, the base station may identify AI/ML functionalities or AI/ML models supportable by the terminal, and may instruct the terminal to activate a specific AI/ML functionality or AI/ML model based on the identified AI/ML functionalities or AI/ML models.

The communication node 200 may perform LCM for the AI/ML models based on the identification of the AI/ML functionalities or the identification of the AI/ML models. For example, the communication node 200 may perform functionality-based LCM for the AI/ML models or model ID-based LCM for the AI/ML models. The functionality-based LCM may be a process in which the base station and the terminal share functionality information for the AI/ML functionalities in advance and identify and manage the AI/ML functionalities based on the shared functionality information. The model ID-based LCM may be a process in which the base station and the terminal share model information along with model IDs in advance and identify and manage the AI/ML models based on the shared model information and model IDs.

As described above, the communication network 100 of the present disclosure may perform a specific AI/ML functionality based on AI/ML technology by utilizing an AI/ML model included in at least one of the plurality of communication nodes 110-1, 110-2, 110-3, 120-1, 120-2, 130-1, 130-2, 130-3, 130-4, 130-5, 130-6. The specific AI/ML functionality may include AI/ML channel state information (CSI) feedback enhancement, AI/ML positioning enhancement, or AI/ML beam management in the communication network 100.

FIG. 3 is a conceptual diagram illustrating an exemplary embodiment of a method for enhancing AI/ML CSI feedback in a communication network.

Referring to FIG. 3, an AI/ML functionality using an AI/ML model may be applied to a method for enhancing CSI feedback in a communication network. The CSI feedback may refer to that a terminal reports CSI so that a base station in the communication network can apply a transmission technique such as multiple input multiple output (MIMO) or precoding. The CSI feedback may support feedback information such as channel quality indicator (CSI), precoding matrix indicator (PMI), or rank indicator (RI).

The AI/ML functionality may be applied to an autoencoder, and the autoencoder may perform CSI compression for obtaining a compressed latent representation for an MIMO channel. For example, the autoencoder may include an encoder, a decoder, and hidden layer(s) between the encoder and the decoder. The autoencoder may set the number of neurons in each the hidden layer(s) to be smaller than an input layer so that data compression (or dimensionality reduction) is performed.

FIG. 4 is a conceptual diagram illustrating an exemplary embodiment of a method for enhancing AI/ML positioning in a communication network.

Referring to FIG. 4, an AI/ML functionality using an AI/ML model may be applied to a method for improving an accuracy of estimating a position of a specific terminal in a communication network.

The positioning accuracy enhancement method to which the AI/ML functionality is applied may include a direct AI/ML positioning method or an AI/ML-assisted positioning method. The direct AI/ML positioning method may be a method in which an AI/ML model receives channel impulse responses (CIRs) or reference signal received powers (RSRPs) as inputs and outputs an estimated position of the terminal. The AI/ML-assisted positioning method may be a method in which an AI/ML model receives CIRs or RSRPs as inputs and outputs a time of arrival (TOA) or non-line-of-sight (NLOS) identification result, and derives an estimated position of the terminal using the TOA and NLOS identification result.

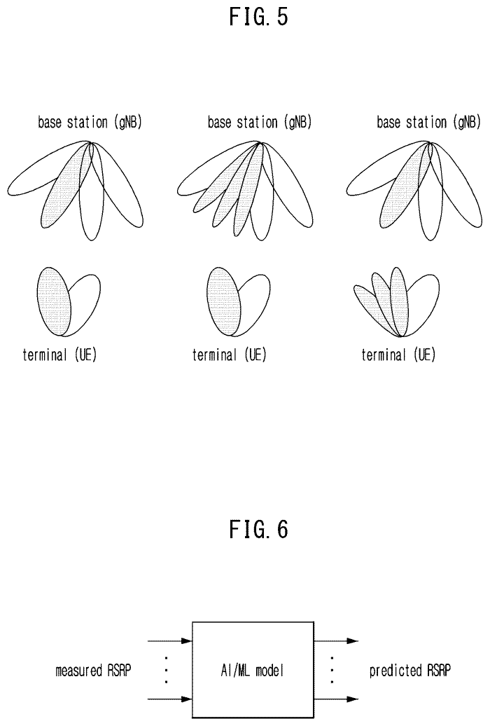

FIG. 5 is a conceptual diagram illustrating an exemplary embodiment of a method for AI/ML beam management in a communication network.

Referring to FIG. 5, an AI/ML functionality using an AI/ML model may be applied to a beam management method capable of improving a reach distance of a directional beam in a communication network.

For example, when a directional beam is used in the communication network, a process for selecting a base station beam (i.e. Tx beam) and a terminal beam (i.e. Rx beam) among multiple beams that provide optimal performance may be necessary for stable link performance between the base station and the terminal. A conventional beam management method for selecting optimal beam(s) may cause performance degradation or increased power consumption due to frequent overhead generation.

The beam management method to which the AI/ML functionality is applied may reduce the overhead generated in beam measurement for optimal beam selection and may improve the accuracy of optimal beam selection. The beam management method to which the AI/ML functionality is applied may perform beam prediction for predicting beams of unobserved resources in the spatial domain or temporal domain.

FIG. 6 is a conceptual diagram illustrating an exemplary embodiment of an AI/ML model for AI/ML beam management.

Referring to FIG. 6, a communication node in a communication network, for example, a base station or a terminal, may include an AI/ML model for AI/ML beam management. The AI/ML model may receive measured performances of beams and output predicted performances of beams through an inference operation.

The measured performances received by the AI/ML model may be beam performances measured by the terminal, for example, layer 1-reference signal received power (L1-RSRP) or layer 1-signal to interference-plus-noise ratio (L1-SINR). The predicted performances output by the AI/ML model may include an index of a beam with the optimal performance among the input measured performances of the beams or performances (e.g. L1-RSRPs) of all available beams.

The terminal may measure a performance of each beam based on a reference signal (RS) received from the base station. The base station may determine the RS based on synchronization signal block (SSB) or channel state information-reference signal (CSI-RS), and transmit the RS to the terminal.

In order for the AI/ML model to perform the AI/ML beam management functionality, operations such as data collection, inference, and model monitoring may be performed. The AI/ML model may be included in the base station or the terminal, and operations of the base station or the terminal for AI/ML beam management may vary depending on the location of the AI/ML model.

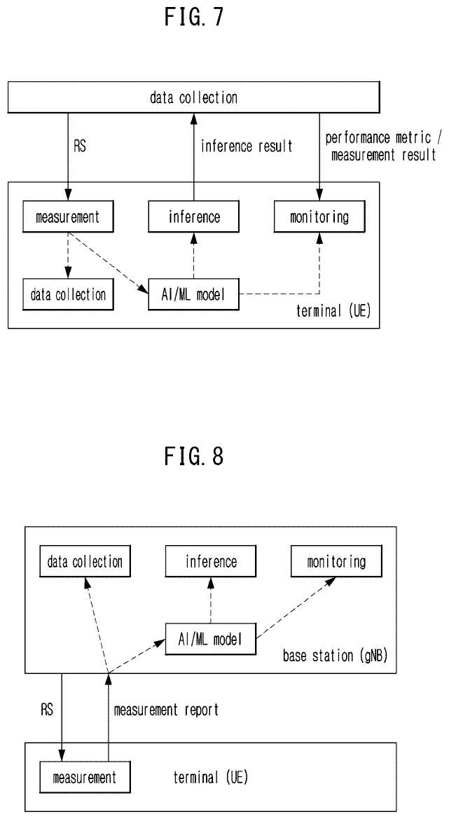

FIG. 7 is a conceptual diagram illustrating an exemplary embodiment of a method for AI/ML beam management using a UE-side AI/ML model.

Referring to FIG. 7, a base station may transmit an RS to a terminal, and the terminal may measure the RS received from the base station. As shown in FIG. 7, since the terminal includes an AI/ML model for AI/ML beam management, the terminal may provide a measurement result of the RS, for example, measured performances of beams, as input to the AI/ML model.

The AI/ML model of the terminal may output a prediction result, for example, predicted performances of beams, through inference based on the input measured performances. The terminal may transmit the predicted performances of beams output from the AI/ML model to the base station.

The terminal may determine a performance metric for the AI/ML model based on the predicted performances output from the AI/ML model. The terminal may transmit the determined performance metric for the AI/ML model to the base station.

The base station may monitor the received performance metric for the AI/ML model for a predetermined time and, and based on a monitoring result, determine an LCM operation for the AI/ML model, for example, activation, deactivation, switching, selection, or fallback of the AI/ML model.

According to an exemplary embodiment, the base station may receive the predicted performances of beams from the terminal and determine the performance metric of the AI/ML model based on the received predicted performances. The terminal may transmit the measurement result of the RS, for example, the measured performances of beams, along with the predicted performances output from the AI/ML model, to the base station to assist performance metric determination at the base station.

FIG. 8 is a conceptual diagram illustrating an exemplary embodiment of a method for AI/ML beam management using a base station-side AI/ML model.

Referring to FIG. 8, a base station may transmit an RS to a terminal, and the terminal may measure the RS received from the base station. As shown in FIG. 8, the base station may include an AI/ML model for AI/ML beam management. The base station may receive a measurement result of the RS, for example, beam measured performances of beams, from the terminal.

The AI/ML model of the base station may output a prediction result, for example, predicted performances of beams, through inference based on the received measured performances. The base station may determine a performance metric for the AI/ML model based on the predicted performances output from the AI/ML model.

The base station may monitor a change in the performance metric for the AI/ML model for a predetermined time and, based on a monitoring result, determine an LCM operation for the AI/ML model, for example, activation, deactivation, selection, switching, or fallback of the AI/ML model.

According to an exemplary embodiment, the base station may transmit the predicted performances output from the AI/ML model to the terminal. The terminal may determine a performance metric for the AI/ML model based on the received predicted performances. The terminal may monitor the performance metric and, and based on a monitoring result, determine an LCM operation for the AI/ML model.

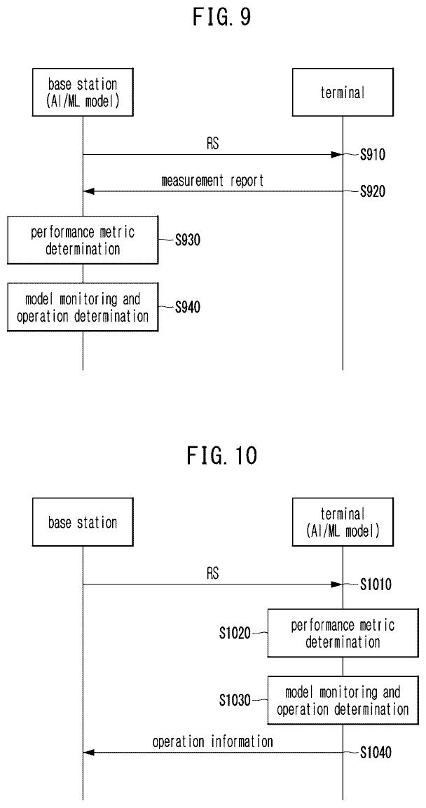

FIG. 9 is a sequence chart illustrating a first exemplary embodiment of a monitoring method for an AI/ML model for AI/ML beam management.

Referring to FIG. 9, a communication network may include a base station and a terminal. The base station may include an AI/ML model for AI/ML beam management in the communication network. The AI/ML model of the base station may be in a state trained using collected data.

The base station may transmit an RS determined based on SSB or CSI-RS to the terminal. The RS may be transmitted using at least one beam or a beam set including at least one beam (S910).

The terminal may measure a performance of each of the at least one beam based on the RS. The terminal may transmit a measurement result, for example, a measured performance for each of the at least one beam, to the base station (S920). The measured performances may include performance values for the at least one beam. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The base station may receive the performance measurement result for each of the at least one beam from the terminal. The AI/ML model of the base station may output a predicted performance value for each of the at least one beam, for example, predicted performance, through inference based on the received measured performances. The predicted performances output from the AI/ML model may include an index of a beam with the best performance among the at least one beam or performances of all available beams.

The base station may determine a performance metric for the AI/ML model based on the predicted performance result of the AI/ML model (S930). The performance metric may include an inference (or prediction) accuracy metric for the AI/ML model, that is, a prediction accuracy metric for the beam performances.

The prediction accuracy metric may include a Top-1 prediction accuracy metric or a Top-k prediction accuracy metric. The Top-1 prediction accuracy metric may be a probability that the beam with the best performance, that is, the beam with the maximum measured performance value, is included in the predicted performances output from the AI/ML model. The Top-k prediction accuracy metric may be a probability that the beam with the maximum measured performance value is included in the predicted performances of k beams output from the AI/ML model.

According to an exemplary embodiment, the AI/ML model may receive a measured L1-RSRP value from the terminal and output a predicted L1-RSRP value through inference. The base station may acquire the measured L1-RSRP value and the predicted L1-RSRP value, and determine the performance metric for the AI/ML model based on a difference between the acquired two values.

The base station may monitor the AI/ML model based on the performance metric of the AI/ML model. The base station may monitor a change in the performance metric for a predetermined period. The base station may determine an operation of the AI/ML model based on a monitoring result (S940).

The base station may monitor whether the performance metric satisfies a predetermined performance condition of the AI/ML model and, based on a monitoring result, determine execution of an LCM operation for the AI/ML model. The LCM operations for the AI/ML model may include model activation, model deactivation, model selection, model switching, or model fallback. The base station may determine an operation of the AI/ML model so that the AI/ML model executes one of the LCM operations based on the monitoring result.

FIG. 10 is a sequence chart illustrating a second exemplary embodiment of a monitoring method for an AI/ML model for AI/ML beam management.

Referring to FIG. 10, a communication network may include a base station and a terminal. The terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1010).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of at least one beam, for example, predicted performance, through inference. The predicted performances output from the AI/ML model may include an index of a beam with the best performance among the at least one beam or performances of all available beams.

The terminal may obtain the predicted performances from the AI/ML model and determine a performance metric for the AI/ML model based on the predicted performances (S1020). The performance metric may include a prediction accuracy metric of the AI/ML model. The prediction accuracy metric may include a Top-1 prediction accuracy metric or a Top-k prediction accuracy metric. When the AI/ML model receives a measured L1-RSRP value, the terminal may determine the performance metric of the AI/ML model based on a difference between the measured L1-RSRP value input to the AI/ML model and a predicted L1-RSRP value output from the AI/ML model.

The terminal may monitor the AI/ML model based on the performance metric of the AI/ML model. The terminal may monitor a change in the performance metric for a predetermined period and, based on a monitoring result, determine execution of an LCM operation for the AI/ML model (S1030).

The LCM operations of the AI/ML model may include model activation, model deactivation, model selection, model switching, or model fallback. The terminal may determine an operation for the AI/ML model so that the AI/ML model executes one of the LCM operations based on the monitoring result. The terminal may transmit a result of determining the operation of the AI/ML model, for example, AI/ML model operation information, to the base station (S1040).

Meanwhile, when the base station or the terminal performs the functionality-based LCM for the AI/ML model, the terminal may determine one of activation, deactivation, switching, or fallback operations for the functionality itself based on the monitoring result of the performance metric and transmit information on the determined operation to the base station. Alternatively, when the base station or the terminal performs the model ID-based LCM for the AI/ML model, the terminal may determine one of activation, deactivation, selection, switching, or fallback operations for the AI/ML model and transmit information on the determined operation to the base station.

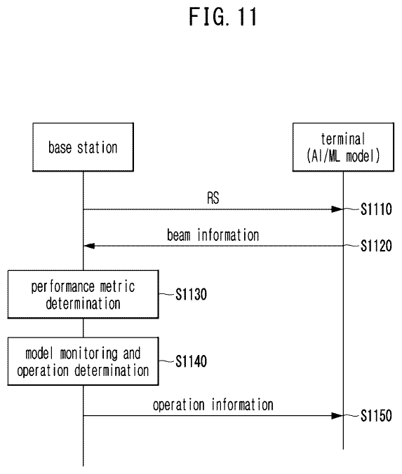

FIG. 11 is a sequence chart illustrating a third exemplary embodiment of a monitoring method for an AI/ML model for AI/ML beam management.

Referring to FIG. 11, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1110).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result for beams and output a predicted performance for each of the at least one beam, for example, predicted performance, through inference. The predicted performances output from the AI/ML model may include an index of a beam with the best performance among the at least one beam or performances of all available beams.

The terminal may generate beam information including the performance measurement result and the predicted performance result output from the AI/ML model for each of the at least one beam, and transmit the beam information to the base station (S1120). For example, the terminal may generate beam information including performance measurement values such as L1-RSRPs or L1-SINRs of the measured beams and predicted performance values including K beam indexes or K beam L1-RSRP values obtained from the AI/ML model, and transmit the generated beam information to the base station.

The base station may determine a performance metric for the AI/ML model based on the beam information received from the terminal (S1130). The performance metric may include a prediction accuracy metric of the AI/ML model, and the prediction accuracy metric may include a Top-1 prediction accuracy metric or a Top-k prediction accuracy metric. According to an exemplary embodiment, the base station may determine the performance metric based on a difference between a beam measurement value and a beam prediction result.

The base station may monitor the AI/ML model based on the performance metric of the AI/ML model. The base station may monitor a change in the performance metric for a predetermined period and, based on a monitoring result, determine execution of an LCM operation for the AI/ML model (S1140).

The LCM operations for the AI/ML model may include model activation, model deactivation, model selection, model switching, or model fallback. The base station may determine an operation of the AI/ML model so that the AI/ML model executes one of the LCM operations based on the monitoring result. The base station may transmit a result of determining the operation of the AI/ML model, for example, AI/ML model operation information, to the terminal (S1150).

Meanwhile, when the base station or the terminal performs the functionality-based LCM for the AI/ML model, the base station may determine one of activation, deactivation, switching, or fallback operations for the functionality itself based on the monitoring result of the performance metric and transmit information on the determined operation to the terminal. Alternatively, when the base station or the terminal performs the model ID-based LCM for the AI/ML model, the base station may determine one of activation, deactivation, selection, switching, or fallback operations for the AI/ML model and transmit information on the determined operation to the terminal.

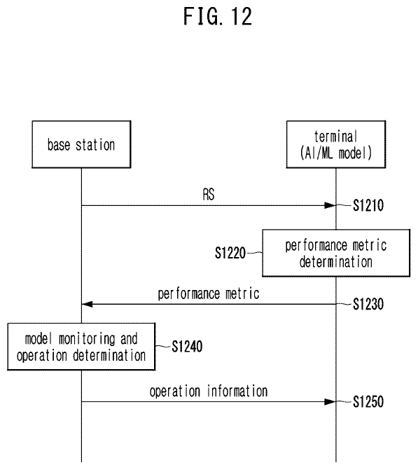

FIG. 12 is a sequence chart illustrating a fourth exemplary embodiment of a monitoring method for an AI/ML model for AI/ML beam management.

Referring to FIG. 12, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1210).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of the at least one beam, for example, predicted performance, through inference. The predicted performances output from the AI/ML model may include an index of a beam with the best performance among the at least one beam or performances of all available beams.

The terminal may obtain the predicted performances from the AI/ML model and determine a performance metric for the AI/ML model based on the predicted performances (S1220). The performance metric may include a prediction accuracy metric of the AI/ML model. The prediction accuracy metric may include a Top-1 prediction accuracy metric or a Top-k prediction accuracy metric. When the AI/ML model receives a measured L1-RSRP value, the terminal may determine the performance metric of the AI/ML model based on a difference between the measured L1-RSRP value input to the AI/ML model and a predicted L1-RSRP value output from the AI/ML model.

The terminal may transmit the performance metric of the AI/ML model to the base station (S1230). The base station may monitor the AI/ML model based on the received performance metric. The base station may monitor a change in the performance metric for a predetermined period. The base station may determine an operation of the AI/ML model based on a monitoring result (S1240).

The base station may monitor whether the performance metric satisfies a predetermined performance condition of the AI/ML model and, based on a monitoring result, determine execution of an LCM operation for the AI/ML model. The LCM operations of the AI/ML model may include model activation, model deactivation, model selection, model switching, or model fallback. The base station may determine an operation of the AI/ML model so that the AI/ML model executes one of the LCM operations based on the monitoring result. The base station may transmit a result of determining the operation of the AI/ML model, for example, AI/ML model operation information, to the terminal (S1250).

Meanwhile, when the base station or the terminal performs the functionality-based LCM for the AI/ML model, the base station may determine one of activation, deactivation, switching, or fallback operations for the functionality itself based on the monitoring result of the performance metric and transmit information on the determined operation to the terminal. Alternatively, when the base station or the terminal performs the model ID-based LCM for the AI/ML model, the base station may determine one of activation, deactivation, selection, switching, or fallback operations for the AI/ML model and transmit information on the determined operation to the terminal.

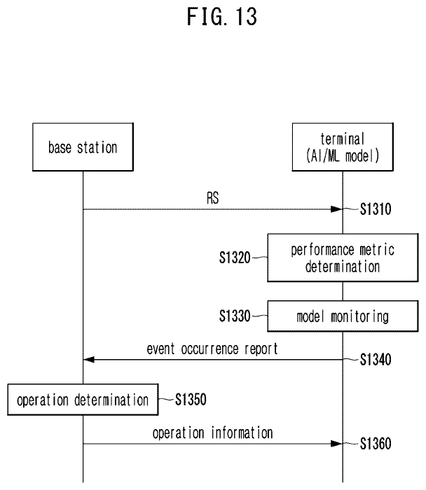

FIG. 13 is a sequence chart illustrating a fifth exemplary embodiment of a monitoring method for an AI/ML model for AI/ML beam management.

Referring to FIG. 13, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1310).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of the at least one beam, for example, predicted performance, through inference. The predicted performances output from the AI/ML model may include an index of a beam with the best performance among the at least one beam or performances of all available beams.

The terminal may obtain the predicted performances from the AI/ML model and determine a performance metric for the AI/ML model based on the predicted performances (S1320). The performance metric may include a prediction accuracy metric of the AI/ML model. The prediction accuracy metric may include a Top-1 prediction accuracy metric or a Top-k prediction accuracy metric. When the AI/ML model receives a measured L1-RSRP value, the terminal may determine the performance metric of the AI/ML model based on a difference between the measured L1-RSRP value input to the AI/ML model and a predicted L1-RSRP value output from the AI/ML model.

The terminal may monitor the AI/ML model based on the performance metric of the AI/ML model. The terminal may monitor a change in the performance metric for a predetermined period (S1330).

The terminal may determine whether an event has occurred during the monitoring of the performance metric. The event may occur when the performance metric does not satisfy a predetermined performance condition for a certain time or a certain number of times. The terminal may transmit an event occurrence report to the base station (S1340).

For example, the terminal may include a counter and may increase a counter value each time the performance metric does not satisfy the performance condition. The terminal may determine occurrence of the event when the increased counter value exceeds a predetermined threshold after a configured monitoring time. The base station may transmit a configured time, a configured condition, or a threshold for the event determination at the terminal through an RRC configuration. According to an exemplary embodiment, the terminal may autonomously configure the configured time, configured condition, or threshold for the event determination.

The base station may receive the event occurrence report from the terminal. The base station may determine execution of an LCM operation for the AI/ML model based on the received event occurrence report (S1350).

For example, when the base station or the terminal performs the functionality-based LCM for the AI/ML model, the base station may determine one of activation, deactivation, switching, or fallback operations for the functionality itself based on the monitoring result of the performance metric and transmit it to the base station. Alternatively, when the base station or the terminal performs the model ID-based LCM for the AI/ML model, the base station may determine one of activation, deactivation, selection, switching, or fallback operations for the AI/ML model. The base station may transmit a result of determining the operation of the AI/ML model, for example, AI/ML model operation information, to the terminal (S1360).

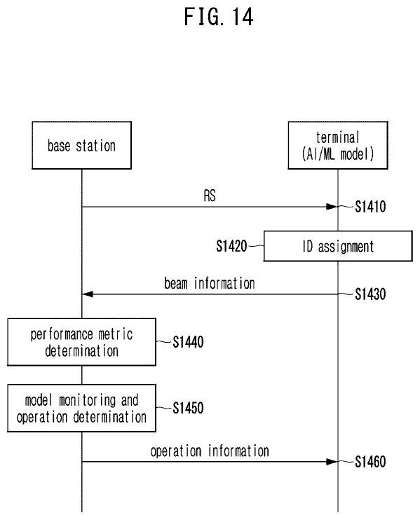

FIG. 14 is a sequence chart illustrating a sixth exemplary embodiment of a monitoring method for an AI/ML model for AI/ML beam management.

Referring to FIG. 14, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1410).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of at least one beam, for example, predicted performance, through inference. The predicted performances output from the AI/ML model may include an index of a beam with the best performance among the at least one beam or performances of all available beams.

The base station may transmit the RS to the terminal through a plurality of beams, and the terminal may output a plurality of performance measurement values for the plurality of beams. The AI/ML model of the terminal may output a plurality of performance prediction values for the plurality of beams. The plurality of performance measurement values or the plurality of performance prediction value may be related to a single AI/ML model or multiple AI/ML models.

The terminal may assign an indicator, for example, a monitoring ID, to each of the plurality of performance measurement values or the plurality of performance prediction values (S1420). The terminal may classify each of the plurality of performance measurement values or the plurality of performance prediction values for each beam set by using the monitoring IDs. The terminal may generate at least one beam information including the performance measurement values or the performance prediction values for each monitoring ID. The terminal may transmit the generated at least one beam information to the base station (S1430).

The base station may receive the at least one beam information from the terminal. The base station may classify the received at least one beam information by the monitoring ID and determine a performance metric of the AI/ML model based on each classified beam information (S1440).

The performance metric may include a prediction accuracy metric of the AI/ML model, and the prediction accuracy metric may include a Top-1 prediction accuracy metric or a Top-k prediction accuracy metric. According to an exemplary embodiment, the base station may determine the performance metric based on a difference between the performance measurement value and the performance prediction value in the beam information.

The base station may monitor the AI/ML model based on the performance metric of the AI/ML model. The base station may monitor a change in the performance metric for a predetermined period. The base station may determine execution of an LCM operation for the AI/ML model based on a monitoring result (S1450).

The base station may monitor whether the performance metric satisfies a predetermined performance condition of the AI/ML model and, based on a monitoring result, determine execution of an LCM operation for the AI/ML model. The LCM operations of the AI/ML model may include model activation, model deactivation, model selection, model switching, or model fallback. The base station may determine an operation of the AI/ML model so that the AI/ML model executes one of the LCM operations based on the monitoring result. The base station may transmit a result of determining the operation of the AI/ML model, for example, AI/ML model operation information, to the terminal (S1460).

When the base station or the terminal performs the functionality-based LCM for the AI/ML model, the base station may determine one of activation, deactivation, switching, or fallback operations for the functionality itself based on the monitoring result of the performance metric and transmit information on the determined operation to the terminal. Alternatively, when the base station or the terminal performs the model ID-based LCM for the AI/ML model, the base station may determine one of activation, deactivation, selection, switching, or fallback operations for the AI/ML model and transmit information on the determined operation to the terminal.

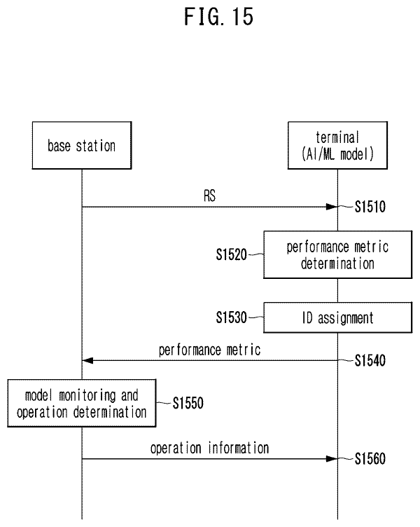

FIG. 15 is a sequence chart illustrating a seventh exemplary embodiment of a monitoring method for an AI/ML model for AI/ML beam management.

Referring to FIG. 15, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1510).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of at least one beam, for example, predicted performance, through inference. The predicted performances output from the AI/ML model may include an index of a beam with the best performance among the at least one beam or performances of all available beams.

The terminal may obtain the predicted performances from the AI/ML model and determine a performance metric for the AI/ML model based on the predicted performances (S1520). The performance metric may include a prediction accuracy metric of the AI/ML model. The prediction accuracy metric may include a Top-1 prediction accuracy metric or a Top-k prediction accuracy metric. When the AI/ML model receives a measured L1-RSRP value, the terminal may determine the performance metric of the AI/ML model based on a difference between the measured L1-RSRP value input to the AI/ML model and a predicted L1-RSRP value output from the AI/ML model.

The base station may transmit the RS to the terminal through a plurality of beams, and the terminal may output a plurality of performance measurement values for the plurality of beams. The AI/ML model of the terminal may output a plurality of predicted performance prediction values for the plurality of beams. The terminal may determine a plurality of performance metrics based on the plurality of predicted performance values. The terminal may assign a monitoring ID to each of the plurality of performance metrics, and classify the plurality of performance metrics based on the monitoring IDs.

The terminal may transmit the plurality of performance metrics to the base station (S1540). The base station may classify the plurality of performance metrics received from the terminal by the monitoring IDs and may monitor a change in each classified performance metric. The base station may determine whether to execute an LCM operation for the AI/ML model based on a monitoring result (S1550).

The base station may monitor whether the performance metric satisfies a predetermined performance condition of the AI/ML model and, based on a monitoring result, determine execution of an LCM operation for the AI/ML model. The LCM operations of the AI/ML model may include model activation, model deactivation, model selection, model switching, or model fallback. The base station may determine an operation of the AI/ML model so that the AI/ML model executes one of the LCM operations based on the monitoring result. The base station may transmit a result of determining the operation of the AI/ML model, for example, AI/ML model operation information, to the terminal (S1460).

When the base station or the terminal performs the functionality-based LCM for the AI/ML model, the base station may determine one of activation, deactivation, switching, or fallback operations for the functionality itself based on the monitoring result of the performance metric and transmit information on the determined operation to the terminal. Alternatively, when the base station or the terminal performs the model ID-based LCM for the AI/ML model, the base station may determine one of activation, deactivation, selection, switching, or fallback operations for the AI/ML model and transmit information on the determined operation to the terminal.

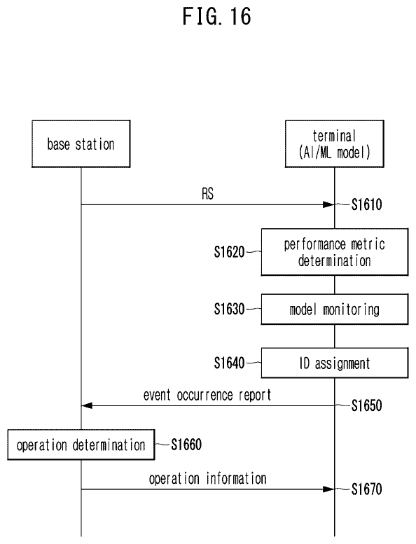

FIG. 16 is a sequence chart illustrating an eighth exemplary embodiment of a monitoring method for an AI/ML model for AI/ML beam management.

Referring to FIG. 16, a communication network may include a base station and a terminal, and the terminal may include an AI/ML model for AI/ML beam management in the communication network. The AI/ML model of the terminal may be in a state trained using collected data.

The base station may transmit an RS determined based on SSB or CSI-RS to the terminal. The RS may be transmitted using at least one beam or a beam set including at least one beam (S1610).

The terminal may measure a performance of each of the at least one beam based on the RS. The measured performance may be represented as L1-RSRP or L1-SINR. The measured performance may be a measurement value for each of a plurality of beams in the entire beam set that the base station can transmit, a measurement value for each of at least one beam in a specific beam set corresponding to a subset of the entire beam set, or a measurement value for each of beams selected from the entire beam set.

The AI/ML model of the terminal may receive the performance measurement result and output a predicted performance value for each of at least one beam, for example, predicted performance, through inference. The predicted performances output from the AI/ML model may include an index of a beam with the best performance among the at least one beam or performances of all available beams.

The terminal may obtain a performance prediction result from the AI/ML model and may determine a performance metric of the AI/ML model based on the performance prediction result (S1620). The performance indicator may include a prediction accuracy indicator of the AI/ML model. The prediction accuracy indicator may include a Top-1 prediction accuracy indicator or a Top-k prediction accuracy indicator. When the AI/ML model receives a measured L1-RSRP value, the terminal may determine the performance metric of the AI/ML model based on a difference between the measured L1-RSRP value input to the AI/ML model and a predicted L1-RSRP value output from the AI/ML model.

The terminal may monitor the AI/ML model based on the performance metric of the AI/ML model. The terminal may monitor a change in the performance metric for a predetermined time (S1630).

The terminal may determine whether an event has occurred during the monitoring of the performance metric. The event may occur when the performance metric fails to satisfy a predetermined performance condition for a predetermined time or a predetermined number of times.

The AI/ML model may output a plurality of performance prediction values from performance measurement values for the plurality of beams of the terminal. The terminal may determine a plurality of performance metrics based on the plurality of performance prediction values. The terminal may perform monitoring for each of the plurality of performance metrics, and a plurality of events may occur during the monitoring.

The terminal may assign a monitoring ID to each of the plurality of events and may classify the plurality of events based on the monitoring IDs (S1640). The terminal may generate a plurality of event occurrence reports based on the monitoring IDs and may transmit the plurality of event occurrence reports to the base station (S1650).

The base station may classify the plurality of event occurrence reports received from the terminal based on the monitoring IDs and may determine whether to execute an LCM operation for the AI/ML model based on the classified event occurrence reports (S1660).

When the base station or the terminal performs the functionality-based LCM for the AI/ML model, the base station may determine one of activation, deactivation, switching, or fallback operations for the functionality itself based on the received event occurrence report(s). Alternatively, when the base station or the terminal performs the model ID-based LCM for the AI/ML model, the base station may determine one of activation, deactivation, selection, switching, or fallback operations for the AI/ML model. The base station may transmit a result of determining the operation of the AI/ML model, for example, AI/ML model operation information, to the terminal (S1670).

As described with reference to FIG. 9 to FIG. 16, the present disclosure may propose AI/ML beam management in the communication network through an AI/ML model included in one of the base station or the terminal. To improve the reliability of AI/ML beam management, the AI/ML model needs to maintain consistency. For example, the AI/ML model may perform training through data collection, and the trained AI/ML model may be included in the base station or the terminal to perform an inference operation for AI/ML beam management. The AI/ML model may ensure consistency by maintaining the performance in the inference operation as achieved in the training process.

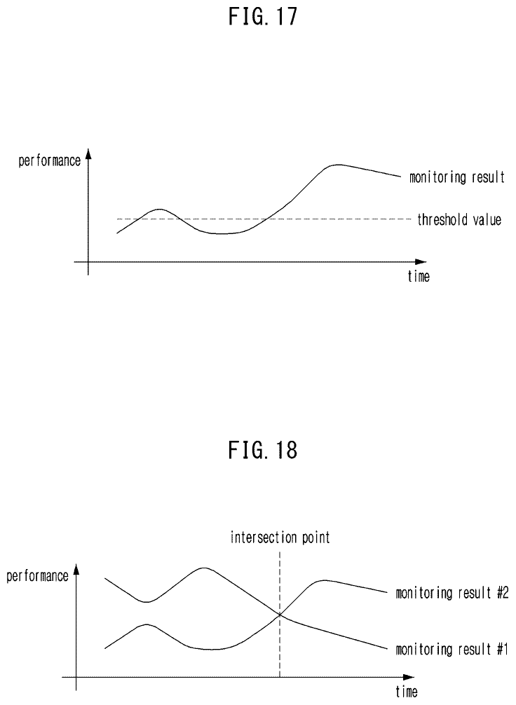

FIG. 17 is a conceptual diagram illustrating a first exemplary embodiment for ensuring consistency between training and inference of an AI/ML model for AI/ML beam management, and FIG. 18 is a conceptual diagram illustrating a second exemplary embodiment for ensuring consistency between training and inference of an AI/ML model for AI/ML beam management.

Hereinafter, for convenience of description, an exemplary embodiment in which the terminal includes an AI/ML model for AI/ML beam management and maintains consistency between training and inference through monitoring of the AI/ML model will be described.

Referring to FIG. 17, the terminal may determine a performance metric based on an inference result of the AI/ML model and may set a threshold for the performance metric of the AI/ML model. Here, the AI/ML model may be in a deactivated state.

The terminal may monitor a change in the performance metric of the AI/ML model for a predetermined time. When the performance metric of the AI/ML model exceeds the threshold for a predetermined time during the monitoring of the terminal, the terminal may determine an activation operation of the AI/ML model. The terminal may perform an inference operation for AI/ML beam management in the communication network using the activated AI/ML model.

Referring to FIG. 18, the terminal may include a plurality of AI/ML models, for example, a first AI/ML model and a second AI/ML model. The terminal may determine a first performance metric based on an inference result of the first AI/ML model and may determine a second performance metric based on an inference result of the second AI/ML model. Here, the first AI/ML model may be in an activated state, and the second AI/ML model may be in a deactivated state.

The terminal may monitor a change in each of the first performance metric and the second performance metric for a predetermined time. During the monitoring of the terminal, an intersection point where the first performance metric and the second performance metric cross may occur at a specific time. In FIG. 18, the intersection point may occur at a time when the first performance metric decreases and the second performance metric increases.

The terminal may determine a switching operation between the first AI/ML model and the second AI/ML model based on the occurrence of the intersection point. The first AI/ML model may switch from the activated state to the deactivated state, and the second AI/ML model may switch from the deactivated state to the activated state. The terminal may perform an inference operation for AI/ML beam management using the activated second AI/ML model.

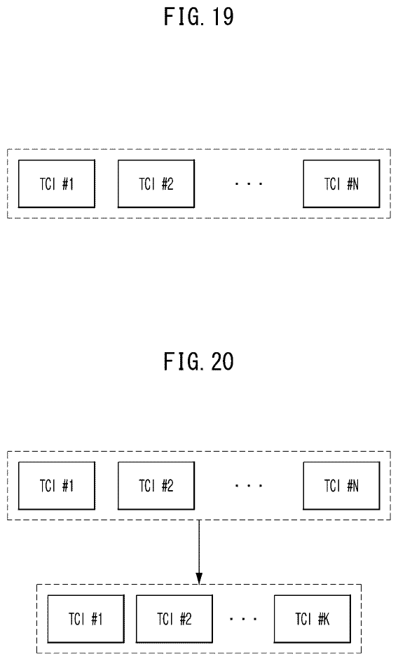

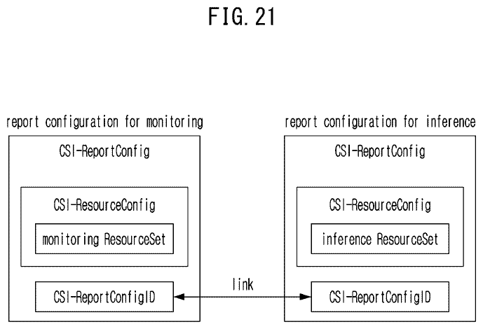

FIG. 19 is a conceptual diagram illustrating a first exemplary embodiment of a beam set configuration method for RS measurement of an AI/ML model for AI/ML beam management, FIG. 20 is a conceptual diagram illustrating a second exemplary embodiment of a beam set configuration method for RS measurement of an AI/ML model for AI/ML beam management, and FIG. 21 is a conceptual diagram illustrating a third exemplary embodiment of a beam set configuration method for RS measurement of an AI/ML model for AI/ML beam management.

The terminal may include an AI/ML model for AI/ML beam management. The terminal may receive an RS from the base station. Based on a measurement result of the received RS, for example, beam measurement performance, the terminal may perform training, inference, or monitoring for the AI/ML model.

Before the base station transmits the RS to the terminal, the terminal may transmit information on a beam set required for training, inference, or monitoring of the AI/ML model to the base station. The base station may transmit the RS to the terminal based on the beam set information received from the terminal. According to an exemplary embodiment, when the base station includes an AI/ML model, the base station may transmit an RS to the terminal through an arbitrary beam set.

The base station may transmit the RS to the terminal through an entire beam set (e.g. Set A) available for transmission, for training of the AI/ML model. The base station may transmit the RS to the terminal through a specific beam set (e.g. Set B), for inference of the AI/ML model. The base station may transmit the RS to the terminal through an entire beam set available for transmission or a specific beam set, for monitoring of the AI/ML model. Additionally, according to an exemplary embodiment, the base station may transmit the RS to the terminal through a separately configured beam set, rather than the entire beam set available for transmission or the specific beam set, for monitoring of the AI/ML model.

The base station may use transmission configuration indication (TCI) signaling to configure the beam set(s) for the RS. As illustrated in FIG. 19, the base station may configure a plurality of parameters (e.g. TCI #1, TCI #2, . . . . And TCI #N) defining TCI states for a plurality of beams (e.g. N beams). The base station may transmit the RS for the N beams to the terminal based on the plurality of parameters (e.g. TCI #1, TCI #2, . . . , and TCI #N).

As illustrated in FIG. 20, the base station may configure a plurality of parameters (e.g. TCI #1, TCI #2, . . . , and TCI #N) defining TCI states for all beams available (e.g. N beams) for transmission though higher layer signaling. The base station may transmit the RS for K beams to the terminal through a predetermined number of parameters (e.g. TCI #1, TCI #2, . . . , and TCI #K) corresponding to K beams, selected from among the plurality of parameters (e.g. TCI #1, TCI #2, TCI #N).

As illustrated in FIG. 21, the base station may transmit information on a resource set for a set of beams (e.g. an entire beam set or a specific beam set) to the terminal for beam performance inference by the AI/ML model. The base station may use a CSI framework for transmitting the resource set information, and may include the resource set information in CSI-ReportConfig to transmit the resource set information to the terminal through an RRC configuration.

Since the resource set information for the entire beam set is required for monitoring of the AI/ML model, the resource set information may be included in a report configuration for monitoring. The resource set information for the entire beam set may be defined as an additional field(s) within CSI-ReportConfig of the report configuration for monitoring. Since the resource set information for a specific beam set is required for inference of the AI/ML model, the resource set information may be included in a report configuration for inference. The resource set information for the specific beam set may be defined as additional field(s) within CSI-ReportConfig of the report configuration for inference.

The terminal may require resource set information for the entire beam set or a specific beam set, which is related to input or output of the AI/ML model, to determine a performance metric for monitoring of the AI/ML model. As illustrated in FIG. 21, the resource set information for the entire beam set and the resource set information for the specific beam set may be located in different CSI-ReportConfig information elements (IEs). Accordingly, the different CSI-ReportConfig IEs may be linked for determining a performance metric of the AI/ML model.

For example, the terminal may set a CSI-ReportConfigId of each of two CSI-ReportConfig IEs to the same value. Thus, the report configuration for monitoring of the AI/ML model and the report configuration for inference may be linked. As another exemplary embodiment, the terminal may set a separate linkage ID for each of the two CSI-ReportConfig IEs and may link the report configuration for monitoring of the AI/ML model and the report configuration for inference through the linkage ID.

As described above, the base station may transmit the RS to the terminal through the entire beam set or specific beam set, for training, inference, or monitoring of the AI/ML model of the terminal.

The base station may transmit the RS to the terminal though the entire beam set (e.g. Set A) to improve accuracy in performance measurement (i.e. performance monitoring) of the AI/ML model of the terminal. In this case, since overhead for transmission of the entire beam set may increase, the base station may transmit the RS to the terminal through a partial beam set (e.g. Set B) of the entire beam set. The terminal may receive the RS from the base station through the partial beam set, rather than the entire beam set, and may perform performance monitoring of the AI/ML model based on the RS received through the partial beam set.

In this case, the partial beam set transmitted from the base station to the terminal may not include key beam(s) (e.g. Top-1 or Top-k beams) for inference or monitoring of the AI/ML model. In this case, accuracy of performance monitoring of the AI/ML model of the terminal may decrease.

Accordingly, when the RS is transmitted from the base station to the terminal through the partial beam set, the base station may cause the terminal to perform performance monitoring of the AI/ML model using at least one beam satisfying a predetermined condition from the partial beam set received by the terminal. For example, the base station may enable performance monitoring of the AI/ML model when an actual measurement result value or a prediction result value of the AI/ML model for the partial beam set of the terminal has L1-RSRP or L1-SINR equal to or greater than a predetermined threshold. To this end, the base station may transmit information on the threshold to the terminal through an RRC configuration.

Meanwhile, the partial beam set transmitted from the base station to the terminal may not include a beam having L1-RSRP or L1-SINR equal to or greater than the above-described threshold. In this case, the terminal may transmit, to the base station, an event occurrence report indicating that a beam having L1-RSRP or L1-SINR equal to or greater than the threshold is not included in the partial beam set. The base station may generate and transmit a new RS to the terminal by changing a ratio of the partial beam set to the entire beam set (e.g. by increasing the number of beams included in the partial beam set or changing the configuration of the partial beam set) based on the event occurrence report received from the terminal.

The base station may divide the entire beam set into a predetermined number of parts and may transmit a plurality of RS, each configured with one of the divided beam sets, to the terminal as signals for inference or monitoring of the AI/ML model. The base station may transmit, to the terminal, information on the number of beams configured for each of the plurality of RSs through an RRC configuration or another method. The base station may transmit the plurality of RSs to the terminal at regular time intervals.

The terminal may receive each of the plurality of RSs from the base station at regular time intervals. The terminal may measure each of the plurality of RSs and may sequentially provide a plurality of beam measurement performances to the AI/ML model based on the measurement results. Additionally or alternatively, the terminal may provide the AI/ML model with a single beam measurement performance by combing the plurality of measurement results for the plurality of RSs.

The AI/ML model of the terminal may output a plurality of beam prediction performances through inference based on the sequentially input beam measurement performances. The terminal may determine a performance metric of the AI/ML model based on the plurality of beam prediction performances output from the AI/ML model. The terminal may accumulate a predetermined number of beam prediction performances and determine an average value to improve reliability of performance metric determination, and may determine the performance metric of the AI/ML model based on the determined average value.

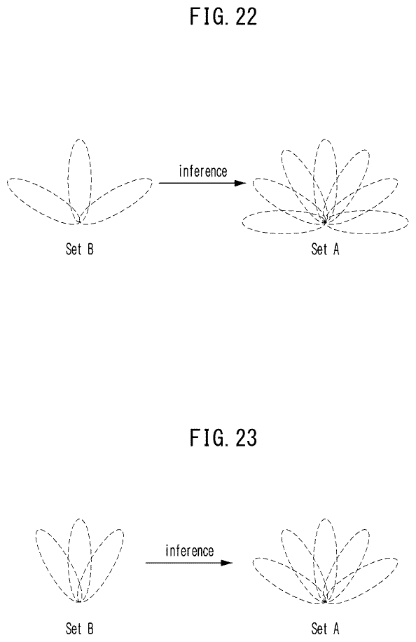

FIG. 22 is a conceptual diagram illustrating a first exemplary embodiment of an inference operation of an AI/ML model for spatial domain AI/ML beam management, and FIG. 23 is a conceptual diagram illustrating a second exemplary embodiment of an inference operation of an AI/ML model for spatial domain AI/ML beam management.

The AI/ML model may predict beam performance through inference in the spatial domain. The spatial domain beam performance prediction of the AI/ML model may be a process of selecting an optimal beam at a specific time based on beam measurement performance measured at a specific time.

Referring to FIG. 22, the terminal may include the AI/ML model. The terminal may measure performances of a beam set (e.g. Set B) at a specific time and may provide a measurement result as an input to the AI/ML model. The AI/ML model may output a beam performance prediction result (e.g. predicted performances for a beam set (e.g. Set A) through inference based on the input measurement result.

Here, when the beam set Set B is a subset of the beam set Set A, the AI/ML model may output predicted performances for the entire beam set Set A through inference based on the measurement result of the beam set Set B.

Referring to FIG. 23, the terminal may include the AI/ML model. The terminal may measure performances of a beam set (e.g. Set B) at a specific time and may provide a measurement result as an input to the AI/ML model. The AI/ML model may output a beam performance prediction result (e.g. predicted performances for a beam set (e.g. Set A) through inference based on the input measurement result.

Here, the beam set Set B may not be a subset of the beam set Set A. For example, the beam set Set A may be a set of narrow beams, whereas the beam set Set B may be a set of wide beams. The AI/ML model may output predicted performances for the wide beam set Set A through inference based on the measurement result of the narrow beam set Set B.

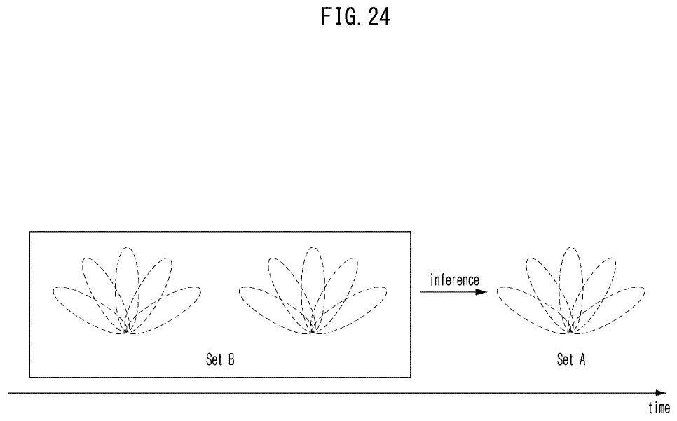

FIG. 24 is a conceptual diagram illustrating an exemplary embodiment of an inference operation of an AI/ML model for temporal domain AI/ML beam management.

The AI/ML model may predict beam performance through inference in the temporal domain. The temporal domain beam performance prediction of the AI/ML model may be a process of selecting an optimal beam at a present or future time based on beam measurement performance measured at a present or past time.

Referring to FIG. 24, the terminal may include the AI/ML model. The terminal may measure performances of a beam set (e.g. Set B) at a present or past time and may provide a measurement result as an input to the AI/ML model. The AI/ML model may output a beam performance prediction result for a present or future time (e.g. predicted performances for a beam set (e.g. Set A) through inference based on the input measurement result.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving a reference signal (RS) for at least one beam from a base station;
obtaining a performance measurement result by measuring a performance of each of the at least one beam based on the reference signal;
obtaining a performance prediction result of each of the at least one beam from an artificial intelligence (AI)/machine learning (ML) model based on the performance measurement result;
determining a performance metric of the AI/ML model based on the performance prediction result; and
determining an operation of the AI/ML model by monitoring the performance metric.

2. The method according to claim 1, wherein the determining of the performance metric comprises:
transmitting, to the base station, beam information including the performance measurement result and the performance prediction result; and
receiving, from the base station, the performance metric of the AI/ML model determined based on the beam information.

3. The method according to claim 1, wherein the determining of the performance metric comprises: determining, as the performance metric, a probability that a beam having a maximum value in the performance measurement result among the at least one beam is included in the performance prediction result.

4. The method according to claim 1, wherein the determining of the performance metric comprises: determining, as the performance metric, a difference between the performance measurement result and the performance prediction result.

5. The method according to claim 1, wherein the determining of the operation of the AI/ML model comprises:
monitoring whether the performance metric satisfies a preconfigured performance condition; and
determining one operation among life cycle management (LCM) operations of the AI/ML model based on a result of the monitoring.

6. The method according to claim 5, wherein the determining of the operation of the AI/ML model further comprises:
determining whether an event occurs based on the result of the monitoring;
in response to the event occurring, transmitting an event occurrence report to the base station; and
receiving, from the base station, information on the operation of the AI/ML model determined based on the event occurrence report.

7. The method according to claim 6, wherein the determining of whether the event occurs comprises:
increasing a count value whenever the performance metric fails to satisfy the performance condition for a preset time; and
in response to the increased count value being equal to or greater than a preset threshold, determining occurrence of the event.

8. The method according to claim 5, wherein the determining of the operation of the AI/ML model comprises:
transmitting the performance metric to the base station; and
receiving, from the base station, information on the operation of the AI/ML model determined based on the performance metric.

9. The method according to claim 1, further comprising:
assigning a monitoring identifier (ID) to at least one of the performance measurement result, the performance prediction result, or the performance metric; and
transmitting the monitoring ID to the base station.

10. A method of a base station, comprising:
transmitting a reference signal (RS) for at least one beam to a user equipment (UE);
receiving, from the UE, a performance measurement result for each of the at least one beam;
obtaining a performance prediction result for each of the at least one beam from an artificial intelligence (AI)/machine learning (ML) model based on the performance measurement result;
determining a performance metric of the AI/ML model based on the performance prediction result;
monitoring the performance metric to determine an operation of the AI/ML model; and
transmitting information on the determined operation of the AI/ML model to the UE.

11. The method according to claim 10, wherein the determining of the performance metric comprises: determining, as the performance metric, one of a probability that a beam having a maximum value in the performance measurement result among the at least one beam is included in the performance prediction result or a difference between the performance measurement result and the performance prediction result.

12. The method according to claim 10, wherein the determining of the operation of the AI/ML model comprises:
monitoring whether the performance metric satisfies a preconfigured performance condition; and
determining one operation among life cycle management (LCM) operations of the AI/ML model based on a result of the monitoring.

13. A user equipment (UE) comprising at least one processor, wherein the at least one processor causes the UE to perform:
receiving a reference signal (RS) for at least one beam from a base station;
obtaining a performance measurement result by measuring a performance of each of the at least one beam based on the reference signal;
obtaining a performance prediction result of each of the at least one beam from an artificial intelligence (AI)/machine learning (ML) model based on the performance measurement result;
determining a performance metric of the AI/ML model based on the performance prediction result; and
determining an operation of the AI/ML model by monitoring the performance metric.

14. The UE according to claim 13, wherein the at least one processor further causes the UE to perform:
transmitting, to the base station, beam information including the performance measurement result and the performance prediction result; and
receiving, from the base station, the performance metric of the AI/ML model determined based on the beam information.

15. The UE according to claim 13, wherein the at least one processor further causes the UE to perform: determining, as the performance metric, one of a probability that a beam having a maximum value in the performance measurement result among the at least one beam is included in the performance prediction result or a difference between the performance measurement result and the performance prediction result.

16. The UE according to claim 13, wherein the at least one processor further causes the UE to perform:
monitoring whether the performance metric satisfies a preconfigured performance condition; and
determining one operation among life cycle management (LCM) operations of the AI/ML model based on a result of the monitoring.

17. The UE according to claim 13, wherein the at least one processor further causes the UE to perform:
determining whether an event occurs based on the result of the monitoring;
in response to the event occurring, transmitting an event occurrence report to the base station; and
receiving, from the base station, information on the operation of the AI/ML model determined based on the event occurrence report.

18. The UE according to claim 17, wherein the at least one processor further causes the UE to perform:
increasing a count value whenever the performance metric fails to satisfy the performance condition for a preset time; and
in response to the increased count value being equal to or greater than a preset threshold, determining occurrence of the event.

19. The UE according to claim 13, wherein the at least one processor further causes the UE to perform:
transmitting the performance metric to the base station; and
receiving, from the base station, information on the operation of the AI/ML model determined based on the performance metric.

20. The UE according to claim 13, wherein the at least one processor further causes the UE to perform:
assigning a monitoring identifier (ID) to at least one of the performance measurement result, the performance prediction result, or the performance metric; and
transmitting the monitoring ID to the base station.
